(19) United States
(12) Patent Application Publication
(10) Pub. No.: US 2024/0258028 A1
(43) Pub. Date: Aug. 1, 2024

(54) INTEGRALLY FORMED INDUCTOR AND MANUFACTURING METHOD THEREFOR

(71) Applicant: MAZO TECH CO., LTD., Jiangsu (CN)

(72) Inventors: Haibo LIU, Jiangsu (CN); Xiaobing ZHOU, Jiangsu (CN); Pan LIU, Jiangsu (CN)

(21) Appl. No.: 18/559,856

(22) PCT Filed: Dec. 27, 2022
(86) PCT No.: PCT/CN2022/142390

§ 371 Date: Nov. 9, 2023

(30) Foreign Application Priority Data
Mar. 30, 2022 (CN) 202210325502.6

(51) Int. Cl. H01F 41/076; H01F 3/08; H01F 17/04; H01F 41/02

(52) U.S. Cl. CPC H01F 41/076; H01F 3/08; H01F 17/045; H01F 41/0246; H01F 2017/048

(57) ABSTRACT

The present disclosure relates to an integrally formed inductor and a manufacturing method therefor. The method comprises: placing a coil into a mold, wherein the coil is wound in a predetermined shape; bending a lead of the coil onto the mold; and adding soft magnetic metal powder to the mold for pressing, so as to obtain an integrally formed inductor.

### TECHNICAL FIELD

The present disclosure relates to the field of integrally formed inductor technology, and particularly to an integrally formed inductor and a manufacturing method thereof.

### BACKGROUND

Inductors mainly function as a filter, an oscillator, a delayer, a trap and so on in a circuit, and further function to screen a signal, filter noise, stabilize a current, and suppress electromagnetic wave interference, etc. With the development of the inductor manufacturing technology, an integrally formed inductor technology appears. Compared with the conventional inductor, the integrally formed inductor has characteristics of large-current resistance and high-temperature resistance, and is particularly prominent in stability in the circuit. And, the integrally formed inductor is formed by fully-enclosed die-casting, so that the integrally formed inductor has a smaller volume.

In the conventional manufacturing method for an integrally formed inductor, a coil is welded to a lead frame, then placed in a mold and pressed with soft magnetic metal powder, and after the pressing, the lead frame is cut and bent to form an electrode of the inductor. The conventional manufacturing method for the integrally formed inductor makes the production process of the integrally formed inductor complex, and has a low efficiency; further, a space designed for the coil is reduced because the lead frame is embedded in the soft magnetic metal powder, the pressed density of the soft magnetic metal powder is low, so that the material characteristics of the soft magnetic metal powder cannot be fully exerted, and the cost of the lead frame is high. The electrode forming needs to be cut and bent so that the material is wasted, and when the coil is put into the mold, it cannot be ensured whether the coil can satisfy the position requirement of the processing specification required for producing the integrally formed inductor, which may cause the coil to be in a skewed state and accordingly reduces the product performance of the integrally formed inductor.

### SUMMARY

In view of this, as for the above technical problem, it is necessary to provide an integrally formed inductor and a manufacturing method thereof, in which the coil structure is simple, the production efficiency high, the production cost is low, the space designed for the coil is increased, the material characteristics of the soft magnetic metal powder are fully exerted, and it is ensured that the position of the coil in the core is not skewed.

In the first aspect of the present disclosure, a method for manufacturing an integrally formed inductor is provided, including: arranging a coil in a mold, the coil being wound into a predetermined shape; bending a lead wire of the coil onto the mold; adding a soft magnetic metal powder into the mold and pressing the soft magnetic metal powder to obtain the integrally formed inductor.

In an embodiment, the arranging the coil in the mold, the coil being wound into a predetermined shape may include: arranging the coil in a support core obtained by pre-pressing; the bending the lead wire of the coil onto the mold comprises: bending the lead wire of the coil arranged in the support core onto a rear surface of the support core; arranging the coil with the lead wire bent onto the rear surface of the support core and the support core together in the mold.

In an embodiment, the arranging the coil in the support core obtained by pre-pressing may include: arranging the coil in the support core obtained by pre-pressing the soft magnetic metal powder.

In an embodiment, the arranging the coil in the support core obtained by pre-pressing the soft magnetic metal powder may include: arranging the coil in the support core obtained by pre-pressing the soft magnetic metal powder in a cold-pressing mode.

In an embodiment, the arranging the coil in the support core obtained by pre-pressing the soft magnetic metal powder with the cold pressing may include: arranging the coil in the support core obtained by pre-pressing the soft magnetic metal powder with the cold pressing at a room temperature.

In an embodiment, the arranging the coil in the mold, the coil being wound into the predetermined shape may include: arranging the coil in the mold, the coil being wound into the predetermined shape, and the predetermined shape may include a circular shape in which the coil is wound, and a right angle to which the lead wire of the coil is bent.

In an embodiment, the bending the lead wire of the coil onto the mold may include: bending the lead wire of the coil into a right-angle shape; bending the lead wire of the coil bent in the right-angle shape onto the mold.

In an embodiment, the adding the soft magnetic metal powder into the mold and pressing the soft magnetic metal powder to obtain the integrally formed inductor may include: adding the soft magnetic metal powder into the mold and performing hot pressing to obtain the integrally formed inductor.

In an embodiment, the adding the soft magnetic metal powder into the mold and performing the hot pressing to obtain the integrally formed inductor may include: adding the soft magnetic metal powder into the mold and performing the 160° C. hot pressing to obtain the integrally formed inductor.

In the second aspect of the present disclosure, an integrally formed inductor is provided, which is manufactured according to the method according to any one of the above embodiments.

In the embodiments of the present disclosure, the coil is arranged into the mold, the coil is wound into the predetermined shape; the lead wire of the coil is bent onto the mold; the soft magnetic metal powder is added into the mold and is pressed to obtain the integrally formed inductor, accordingly, the coil structure of the integrally formed inductor is simple, the production efficiency is high, and the production cost of the integrally formed inductor is reduced without welding the lead frame and the coil, the space designed for the coil can be increased, and the pressing density of the soft magnetic metal powder can be increased, the position of the coil in the magnetic core can be ensured to meet the requirement for producing the integrally formed inductor, so that the position of the coil in the core is not skewed, to guarantee the product characteristics of the integrally formed inductor.

### BRIEF DESCRIPTION OF THE DRAWINGS

In order to more clearly describe the technical solution in the embodiments of the present disclosure or the existing technology, accompanying drawings that need to be used in the description of the embodiments or the existing technology will be briefly introduced. Obviously, the accompanying drawings in the following description are merely some embodiments of the present disclosure. Those of ordinary skill in the art can obtain drawings of other embodiments based on these drawings without creative work.

FIG. 1 is a flow chart showing a method for manufacturing an integrally formed inductor according to an embodiment.

FIG. 2 is a flow chart showing a method for manufacturing an integrally formed inductor according to an embodiment.

FIG. 3 is a flow chart showing a method for manufacturing an integrally formed inductor according to an embodiment.

FIG. 4 is a flow chart showing a method for manufacturing an integrally formed inductor according to an embodiment.

FIG. 5 is a schematic diagram of a planar core in use of a method for manufacturing an integrally formed inductor according to an embodiment.

FIG. 6 is a schematic diagram illustrating a coil in use of a method for manufacturing an integrally formed inductor according to an embodiment.

FIG. 7 is a schematic diagram of bending a coil to a right angle by using a method for manufacturing an integrally formed inductor according to an embodiment.

FIG. 8 is a schematic diagram of a coil bent at a right angle arranged into a mold by using a method for manufacturing an integrally formed inductor according to an embodiment.

FIG. 9 is a schematic diagram of adding a planar core by using a method for manufacturing an integrally formed inductor according to an embodiment.

FIG. 10 is a schematic diagram of bending a lead wire of a coil to a planar core by using a method for manufacturing an integrally formed inductor according to an embodiment.

FIG. 11 is a schematic diagram illustrating an integrally formed inductor according to an embodiment.

FIG. 12 is a schematic diagram of arranging a support core by using a method for manufacturing an integrally formed inductor according to an embodiment.

FIG. 13 is a schematic diagram of arranging a coil in a support core by using a method for manufacturing an integrally formed inductor according to an embodiment.

FIG. 14 is a schematic diagram illustrating an integrally formed inductor according to an embodiment.

### DETAILED DESCRIPTION

In order to make the purpose, technical solution, and advantages of the present disclosure clearer, the present disclosure will be further elaborated below with reference to the accompanying drawings and embodiments. It should be appreciated that the specific embodiments described herein are merely illustrative of the present disclosure and are not intended to limit the present disclosure.

It should be noted that when an element is referred to as being “fixed to” another element, it may be directly on the other element or there may exist an intermediate element. When one element is regarded as being “connected to” another element, it may be directly connected to the other element or there may exist an intermediate element. As used herein, the terms “vertical”, “horizontal”, “left”, “right”, “up”, “down”, “front”, “rear”, “circumference” and the like are based on the azimuth or positional relationship shown in the accompanying drawings and are intended merely to facilitate the description of the disclosure and to simplify the description, and not to indicate or imply that the device or element referred to definitely has a particular azimuth, or is constructed and operated in a particular azimuth, and therefore are not to be construed as limiting the present disclosure.

Unless defined otherwise, all technical and scientific terms used herein have the same meaning as commonly understood by one of ordinary skill in the art to which this disclosure belongs. The terms used in the description of the present disclosure are merely for the purpose of describing specific embodiments and are not intended to limit the present disclosure. As used herein, the term “and/or” includes any and all combinations of one or more of the relevant listed items.

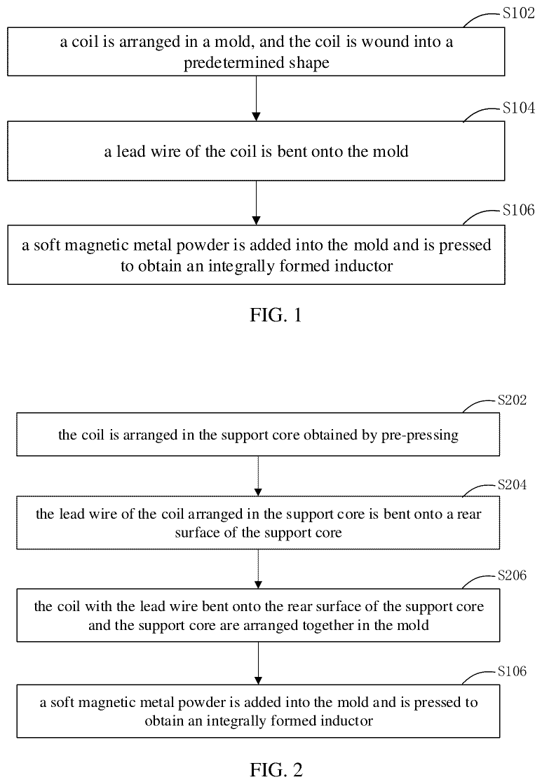

In an embodiment, as shown in FIG. 1, a method for manufacturing an integrally formed inductor is provided, including the following steps S102 to S106.

S102: a coil is arranged in a mold, and the coil is wound into a predetermined shape.

The predetermined shape may include a shape preset according to an actual requirement, and may be, for example, a circular shape, an elliptical shape, or the like.

Specifically, the coil may be wound into a predetermined shape, such as a circular shape or the like, and then the coil wound into the predetermined shape is arranged into the mold. A shape of the mold may be a shape manufactured according to an actual requirement, such as a circular shape, an elliptical shape, or an irregular shape satisfying the actual requirement, etc.

S104: a lead wire of the coil is bent onto the mold.

Specifically, the lead wire of the coil may be bent onto the mold; the bending may include bending according to the shape of the mold so that the coil is attached onto a surface of the mold, and the coil bent onto the mold may serve as an electrode of an integrally formed inductor.

S106: a soft magnetic metal powder is added into the mold and is pressed to obtain an integrally formed inductor.

The soft magnetic metal powder may include a powder for manufacturing a metal magnetic powder core.

Specifically, the soft magnetic metal powder can be added into the mold and then pressed to obtain the integrally formed inductor.

In the above-described method for manufacturing the integrally formed inductor, the coil is arranged in the mold, the coil is wound into the predetermined shape; a lead wire of the coil is bent onto the mold; the soft magnetic metal powder is added into the mold and is pressed to obtain the integrally formed inductor, so that the coil structure of the integrally formed inductor is simple, the production efficiency is high, the production cost of the integrally formed inductor is reduced because there is no need to weld the lead frame to the coil, accordingly the space designed for the coil can be increased, the pressing density of the soft magnetic metal powder is increased, the position of the coil in the core can satisfy the requirement for producing the integrally formed inductor, so that the position of the coil in the core is not skewed to guarantee the product characteristics of the integrally formed inductor.

In an embodiment, as shown in FIG. 2, the step of arranging the coil in the mold, in which the coil is wound into the predetermined shape in the step S102 may include following steps S202 to S206.

S202: the coil is arranged in the support core obtained by pre-pressing.

The support core may include cores configured to arrange the coil. A shape and a structure of the support core may be determined according to the actual requirement. For example, the shape of the support core may include a circular shape, an elliptic shape, a trapezoidal shape, or an irregular shape designed according to the actual requirement, etc.

Specifically, the support core can be obtained by pre-pressing before putting the coil into the support core.

The step S104 of bending the lead wire of the coil onto the mold may include following steps.

S204: the lead wire of the coil arranged in the support core is bent onto a rear surface of the support core.

The step of bending may include that the lead wire of the coil is bent according to the shape of the support core, so that the lead wire of the coil is located on the rear surface of the support core.

Specifically, the lead wire of the coil arranged in the support core is bent onto the rear surface of the support core to serve as an electrode of the integrally formed inductor.

S206: the coil with the lead wire bent onto the rear surface of the support core and the support core are arranged together in the mold.

Specifically, the coil with the lead wire bent onto the rear surface of the support core and the support core are arranged into the mold to perform a pressing procedure for the integrally formed inductor.

In the present embodiment, the coil is arranged in the support core which is obtained by pre-pressing; the lead wire of the coil arranged in the support core is bent onto the rear surface of the support core; the coil with the lead wire bent to the rear surface of the support core and the support core are arranged into the mold, so that the coil structure of the integrally formed inductor is simple, the production efficiency is high, the production cost of the integrally formed inductor is reduced, the space designed for the coil can be increased, and the pressing density of the soft magnetic metal powder is increased, which can ensure that the position of the coil in the core satisfies the requirement for producing the integrally formed inductor, so that the position of the coil in the core is not skewed to guarantee the product characteristics of the integrally formed inductor.

In an embodiment, the step S202 of arranging the coil in the support core obtained by pre-pressing may include:
the coil is arranged in the support core obtained by pre-pressing the soft magnetic metal powder.

Specifically, the support core may be obtained by pre-pressing the soft magnetic metal powder, and then the coil is arranged in the support core.

In the embodiment, the support core is obtained by pre-pressing the soft magnetic metal powder, and then the coil can be arranged in the support core, so that the position of the coil in the core is not skewed.

In an embodiment, the step of arranging the coil in the support core obtained by pre-pressing the soft magnetic metal powder may include:
the coil is arranged in the support core which is obtained by pre-pressing the soft magnetic metal powder in a cold-pressing mode.

Specifically, the support core can be obtained by pre-pressing the soft magnetic metal powder in a cold-pressing mode, and then the coil is arranged into the support core.

The step of arranging the coil in the support core obtained by pre-pressing the soft magnetic metal powder with the cold pressing may include:
the coil is arranged in the support core obtained by pre-pressing the soft magnetic metal powder with the cold pressing at a room temperature.

The room temperature varies with seasons and times, for example, in winter, the room temperature is generally between 18° C. and 25° C., and in summer, the room temperature is generally between 23° C. and 30° C.

Specifically, the support core can be obtained by pre-pressing the soft magnetic metal powder with the cold pressing, and then the coil is arranged in the support core. In some embodiments, the support core may be obtained by pre-pressing the soft magnetic metal powder at the room temperature 20° C., and then the coil is arranged in the support core.

In the present embodiment, the support core is obtained by pre-pressing the soft magnetic metal powder with the cold pressing, and then the coil is arranged in the support core, such that the position of the coil in the core is not skewed, and the material characteristics of the soft magnetic metal powder can be exerted.

In an embodiment, the step S102 of arranging the coil in the mold, the coil being wound into the predetermined shape may include:
the coil is arranged in the mold, the coil is wound into the predetermined shape, the predetermined shape includes a circular shape in which the coil is wound, and a right angle to which the lead wire of the coil is bent.

Specifically, the coil may be wound into the predetermined shape before being arranged in the mold.

In the embodiment, the coil is wound into the predetermined shape before being arranged into the mold, which allows the structure of the coil of the integrally formed inductor to be simple and to have a high production efficiency.

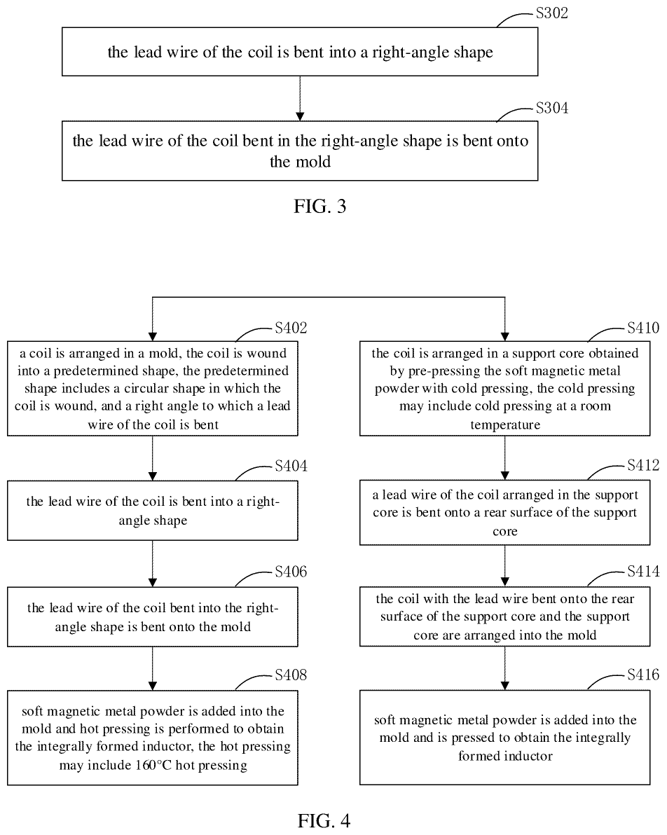

In an embodiment, as shown in FIG. 3, the step S104 of bending the lead wire of the coil onto the mold may include following steps S302 and S304.

S302: the lead wire of the coil is bent into a right-angle shape.

S304: the lead wire of the coil bent in the right-angle shape is bent onto the mold.

Specifically, the lead wire of the coil can be bent into the right-angle shape before being bent onto the mold to form an electrode of the inductor. In some embodiments, the lead wire of the coil may be bent according to the shape of the mold so that the lead wire of the coil is bent and placed onto the mold to allow the lead wire of the coil bent onto the mold to serve as the electrode of the integrally formed inductor.

In the embodiment, the lead wire of the coil is bent into the right-angle shape before being bent onto the mold, and the electrode of the inductor is formed, so that the space designed for the coil can be increased.

In an embodiment, the step of adding the soft magnetic metal powder to the mold and pressing the soft magnetic metal powder to obtain the integrally formed inductor may include:
the soft magnetic metal powder is added into the mold and hot pressing is performed to obtain the integrally formed inductor.

The step of adding the soft magnetic metal powder into the mold and performing the hot pressing to obtain the integrally formed inductor may include:
the soft magnetic metal powder is added into the mold and the hot pressing is performed to obtain the integrally formed inductor, the hot pressing may include 160° C. hot pressing.

Specifically, the soft magnetic metal powder arranged into the mold can be pressed by the hot pressing to obtain the integrally formed inductor. In some embodiments, the pressing may be performed by the 160° C. hot pressing.

In the present embodiment, the soft magnetic metal powder arranged into the mold is pressed by the hot pressing to obtain the integrally formed inductor, so that the coil structure of the integrally formed inductor is simple, the production efficiency is high, and the production cost of the integrally formed inductor is reduced.

In an embodiment, as shown in FIG. 4, a method of manufacturing an integrally formed inductor is provided, including following steps S402 to S416.

S402: a coil is arranged in a mold, the coil is wound into a predetermined shape, the predetermined shape includes a circular shape in which the coil is wound, and a right angle to which a lead wire of the coil is bent.

S404: the lead wire of the coil is bent into a right-angle shape.

S406: the lead wire of the coil bent into the right-angle shape is bent onto the mold.

S408: soft magnetic metal powder is added into the mold and hot pressing is performed to obtain the integrally formed inductor, the hot pressing may include 160° C. hot pressing.

S410: the coil is arranged in a support core obtained by pre-pressing the soft magnetic metal powder in a cold-pressing mode, the cold pressing may include cold pressing at a room temperature.

S412: a lead wire of the coil arranged in the support core is bent onto a rear surface of the support core.

S414: the coil with the lead wire bent onto the rear surface of the support core and the support core are arranged into the mold.

S416: soft magnetic metal powder is added into the mold and is pressed to obtain the integrally formed inductor.

It should be appreciated that although the steps in the flow charts of the drawings are shown in sequence as indicated by the arrows, these steps are not definitely performed in sequence as indicated by the arrows. Unless expressly stated herein, these steps are not performed in a strict order and may be performed in other orders. Moreover, at least part of the steps in the drawings may include a plurality of steps or phases, which steps or phases are not definitely performed at the same time, but may be performed at different time, and the steps or phases are not definitely performed sequentially, but may be performed in turns or alternately with at least part of the steps or phases in other steps or other steps.

In an embodiment, an integrally formed inductor is provided based on the method in any of the above embodiments.

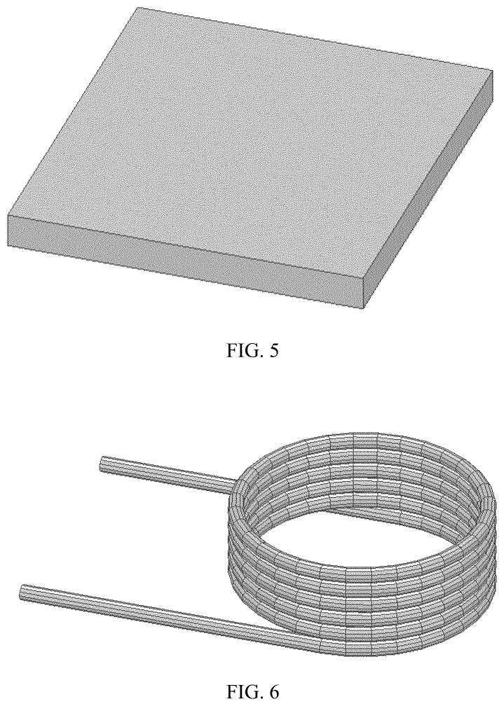

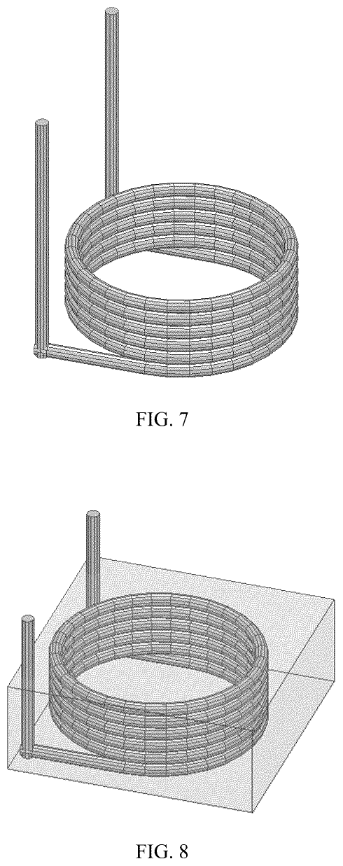

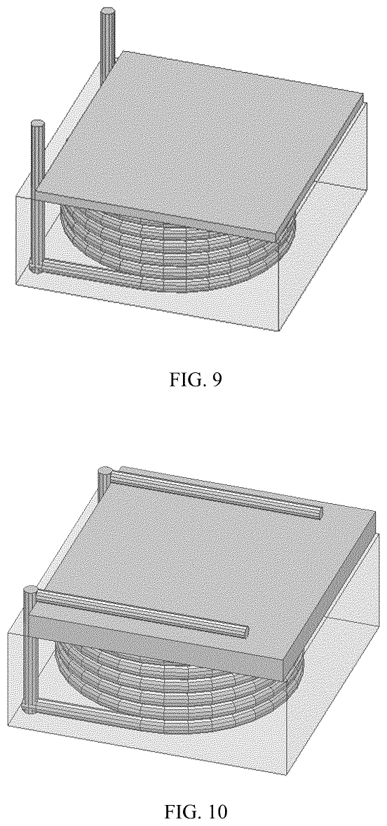

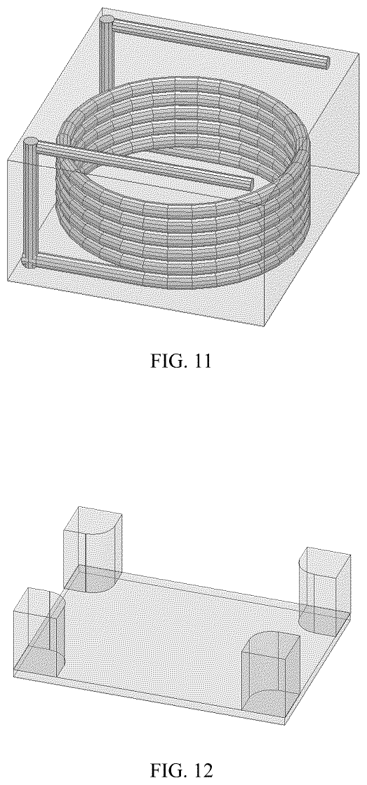

In an embodiment, an integrally formed inductor is provided, which may be manufactured by the following method: firstly, a planar core (as shown in FIG. 5) is obtained by performing the cold pressing on the soft magnetic metal powder, in which the cold pressing may include pressing of the soft magnetic metal powder at a room temperature, or may include cold pressing of the soft magnetic metal powder at a room temperature of 25° C., the room temperature varies with seasons and time of day. The two lead wires of the coil (as shown in FIG. 6) are bent to right angles (as shown in FIG. 7) before being arranged into the mold (as shown in FIG. 8), in which the shape of the coil (as shown in FIG. 6) may include a pre-designed shape according to actual requirements, for example, may be a circular shape or an elliptical shape. The planar core (as shown in FIG. 5) is arranged on the mold (as shown in FIG. 9), and then two lead wires of the coil are bent onto the planar core (as shown in FIG. 10), and the two lead wires of the coil serve as electrodes of the integrally formed inductor. The soft magnetic metal powder is added from the other side of the coil and the hot pressing is performed to obtain the integrally formed inductor (as shown in FIG. 11), in which the hot pressing may include high-temperature pressing at 160° C.

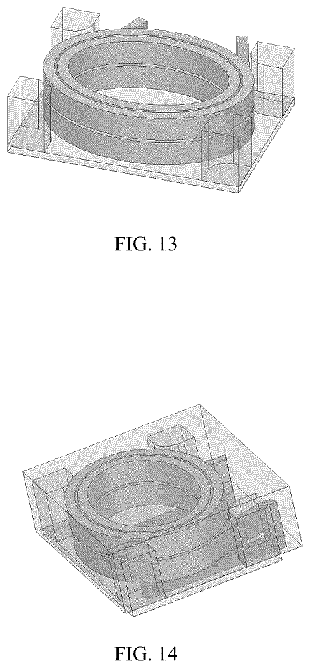

In an embodiment, an integrally formed inductor is provided, which may be manufactured by the following method: firstly, a support core (as shown in FIG. 12) is obtained by performing the cold pressing on the soft magnetic metal powder, in which the cold pressing may include pressing of the soft magnetic metal powder at a room temperature, or may include cold pressing of the soft magnetic metal powder at a room temperature of 25° C., the room temperature varies with seasons and time of day. The coil is arranged in the support core (as shown in FIG. 13), in which the shape of the support core (as shown in FIG. 12) may include a shape adapted to arrange the coil according to actual requirements, the support core (as shown in FIG. 12) can ensure that the coil in the middle portion of the support core is not skewed (as shown in FIG. 12); after that, the two lead wires of the coil are bent onto the rear surface of the support core (as shown in FIG. 12), the support core with the coil is arranged into the mold, and the soft magnetic metal powder is added to perform the hot pressing, and the integrally formed inductor (as shown in FIG. 14) is obtained, in which the hot pressing may include high-temperature pressing at 160° C.

Each of the technical features in the above embodiments may be combined at will. For the sake of brevity, all possible combinations of the technical features in the above embodiments are not described. However, the combinations of these technical features should be regarded as being within the scope of the present disclosure as long as there is no contradiction in these combinations.

The above-described embodiments merely represent some implementation modes of the present disclosure, the descriptions thereof are more specific and detailed, but are not therefore to be construed as limiting the scope of the present disclosure. It should be noted that those skilled in the art can also make several transformations and improvements without departing from the spirit and scope of the present disclosure, which all fall within the scope of the present disclosure. Accordingly, the scope of the protection of the present disclosure should be subject to the appended claims.

1. A method for manufacturing an integrally formed inductor, the method comprising:
arranging a coil in a mold, the coil being wound into a predetermined shape;
bending a lead wire of the coil onto the mold; and
adding soft magnetic metal powder into the mold and pressing the soft magnetic metal powder to obtain the integrally formed inductor.

2. The method according to claim 1, wherein the arranging the coil in the mold, the coil being wound into the predetermined shape comprises:
arranging the coil in a support core obtained by pre-pressing;
wherein the bending the lead wire of the coil onto the mold comprises:
bending the lead wire of the coil arranged in the support core onto a rear surface of the support core; and
arranging the coil with the lead wire bent onto the rear surface of the support core and the support core together in the mold.

3. The method according to claim 2, wherein the arranging the coil in the support core obtained by pre-pressing comprises:
arranging the coil in the support core obtained by pre-pressing the soft magnetic metal powder.

4. The method according to claim 3, wherein the arranging the coil in the support core obtained by pre-pressing the soft magnetic metal powder comprises:
arranging the coil in the support core obtained by pre-pressing the soft magnetic metal powder in a cold-pressing mode.

5. The method according to claim 4, wherein the arranging the coil in the support core obtained by pre-pressing the soft magnetic metal powder with the cold pressing comprises:
arranging the coil in the support core obtained by pre-pressing the soft magnetic metal powder with the cold pressing at a room temperature.

6. The method according to claim 1, wherein the arranging the coil in the mold, the coil being wound into the predetermined shape comprises:
arranging the coil in the mold, wherein the coil is wound into the predetermined shape, the predetermined shape comprising a circular shape in which the coil is wound, and a right angle to which the lead wire of the coil is bent.

7. The method according to claim 1, wherein the bending the lead wire of the coil onto the mold comprises:
bending the lead wire of the coil into a right-angle shape;
bending the lead wire of the coil bent in the right-angle shape onto the mold.

8. The method according to claim 1, wherein the adding the soft magnetic metal powder into the mold and pressing the soft magnetic metal powder to obtain the integrally formed inductor comprises:
adding the soft magnetic metal powder into the mold and performing hot pressing to obtain the integrally formed inductor.

9. The method according to claim 8, wherein the adding the soft magnetic metal powder into the mold and performing the hot pressing to obtain the integrally formed inductor comprises:
adding the soft magnetic metal powder into the mold and performing the hot pressing at 160° C. to obtain the integrally formed inductor.

10. An integrally formed inductor, manufactured according to the method according to claim 1.
